(19) United States
(12) Patent Application Publication
(10) Pub. No.: US 2024/0383762 A1
(43) Pub. Date: Nov. 21, 2024

(54) METHOD FOR PREPARING ALUMINOSILICATE SSZ-82

(71) Applicant: Chevron U.S.A. Inc., San Ramon, CA (US)

(72) Inventors: Christopher Michael Lew, Alameda, CA (US); Rebecca Edyne MacLean, Pleasanton, CA (US); Kurt Owen Jensen, Richmond, CA (US)

(21) Appl. No.: 18/319,462

(22) Filed: May 17, 2023

(51) Int. Cl. C01B 39/48; C01B 37/02

(52) U.S. Cl. CPC C01B 39/48; C01B 37/02; C01P 2002/02

(57) ABSTRACT

A method is disclosed making aluminosilicate SSZ-82. The method includes (1) preparing a reaction mixture comprising: an amorphous alumina source comprising predominantly aluminum hydroxide; an amorphous silica source comprising predominantly colloidal silica; a source of an alkali metal cation; an organic structure directing agent comprising a 1,6-bis(N-cyclohexylpyrrolidinium)hexane dication; hydroxide ions; seed crystals, wherein the seed crystals comprise a crystalline molecular sieve having an SSZ-82 framework; and water; (2) heating the reaction mixture under crystallization conditions including a temperature of from 100° C. to 200° C. for a time sufficient to form crystals of the aluminosilicate zeolite; and (3) recovering at least a portion of the aluminosilicate zeolite from step (2).

### FIELD

The present technology relates to a method for directly synthesizing an aluminosilicate zeolite having the framework structure of SSZ-82.

### BACKGROUND

Molecular sieve SSZ-82 is a single crystalline phase material which has a unique two-dimensional 12-/10-ring channel system. The framework structure of SSZ-82 has been assigned the three-letter code SEW by the Structure Commission of the International Zeolite Association.

The composition and characterizing powder X-ray diffraction pattern of SSZ-82 are disclosed in U.S. Pat. No. 7,820,141, which also describes the synthesis of the molecular sieve in the presence of 1,6-bis(N-cyclohexylpyrrolidinium)hexane dications.

SSZ-82 has been conventionally synthesized in its borosilicate form. Borosilicates contain acid sites generally too weak in acid strength to catalyze many hydrocarbon conversion reactions of commercial interest. While methods are known for converting borosilicate zeolites (with weak inherent acidity) to aluminosilicate zeolites (with much stronger acidity) by various post-synthetic techniques, there remains a need for directly synthesizing SSZ-82 in its aluminosilicate form, thereby eliminating the need for post-synthetic framework modification.

### SUMMARY

In one aspect, there is provided a method of making an aluminosilicate zeolite having a framework structure of SSZ-82, the method comprising: (1) preparing a reaction mixture comprising: (a) an amorphous alumina source comprising predominantly aluminum hydroxide; (b) an amorphous silica source comprising predominantly colloidal silica; (c) a source of an alkali metal cation [M]; (d) an organic structure directing agent [Q] comprising a 1,6-bis(N-cyclohexylpyrrolidinium)hexane dication; (e) hydroxide ions; (f) seed crystals, wherein the seed crystals comprise a crystalline molecular sieve having an SSZ-82 framework; and (g) water; (2) heating the reaction mixture under crystallization conditions including a temperature of from 100° C. to 200° C. for a time sufficient to form crystals of the aluminosilicate zeolite; and (3) recovering at least a portion of the aluminosilicate zeolite from step (2).

### BRIEF DESCRIPTION OF THE DRAWINGS

FIG. 1 shows a Scanning Electron Microscopy (SEM) image of an as-made aluminosilicate SSZ-82 in accordance with Example 1.

FIG. 2 shows a powder X-ray diffraction (XRD) pattern for as-made SSZ-82 (top) and calcined SSZ-82 (bottom) materials of Example 1.

### DETAILED DESCRIPTION

### Definitions and Abbreviations

The term “as-made” refers to a zeolite in its form after crystallization, prior to removal of the organic structure directing agent.

When reference is made to a “predominant” compound, this is understood to mean, for the purposes of the present disclosure, that this compound is predominant among the compounds of the same type in the composition, that is to say that it is the one which represents the greatest amount by weight among the compounds of the same type. Thus, for example, a predominant alumina source is the alumina source representing the greatest weight relative to the total weight of the alumina sources in the composition. Preferably, the term “predominant” is understood to mean present at greater than 50%, preferably greater than 60%, 70%, 80%, 90%, 95%, and more preferentially the “predominant” compound represents 100%. The words “predominantly” and “predominant” are synonymous and equivalent.

A “minor” compound is a compound which does not represent the greatest fraction by weight among the compounds of the same type. The word “minor” and the phrase “to a minor extent” are synonymous and equivalent.

In the disclosure and experimental section which follows, the following abbreviations apply: Al-SSZ-82 (aluminosilicate SSZ-82); B-SSZ-82 (borosilicate SSZ-82); OSDA (organic structure directing agent); d (days); M (molar); g (grams); μmol (micromoles); and cm³ (cubic centimeters).

### Synthesis of the Zeolite

An aluminosilicate zeolite having a framework structure of SSZ-82 can be directly synthesized by: (1) preparing a reaction mixture comprising: (a) an amorphous alumina source comprising predominantly aluminum hydroxide; (b) an amorphous silica source comprising predominantly colloidal silica; (c) a source of an alkali metal cation [M]; (d) an organic structure directing agent [Q] comprising a 1,6-bis(N-cyclohexylpyrrolidinium)hexane dication; (e) hydroxide ions; (f) seed crystals, wherein the seed crystals comprise a crystalline molecular sieve having an SSZ-82 framework; and (g) water; (2) heating the reaction mixture under crystallization conditions including a temperature of from 100° C. to 200° C. for a time sufficient to form crystals of the aluminosilicate zeolite; and (3) recovering at least a portion of the aluminosilicate zeolite from step (2).

The reaction mixture can have a composition, in terms of molar ratios, within the ranges set forth in Table 1:

TABLE 1

| | Broadest | Secondary |
|---|---|---|
| SiO₂/Al₂O₃ | 20 to 150 | 25 to 100 |
| M/SiO₂ | 0.05 to 0.50 | 0.10 to 0.30 |
| Q/SiO₂ | 0.05 to 0.30 | 0.05 to 0.20 |
| OH/SiO₂ | 0.10 to 0.80 | 0.20 to 0.60 |
| H₂O/SiO₂ | 10 to 80 | 20 to 60 |

The amorphous alumina source comprises predominantly aluminum hydroxide. The amorphous alumina source can optionally contain, in minor amount, any type of amorphous alumina other than aluminum hydroxide. For example, the amorphous alumina source can optionally contain, in minor amount, water-soluble aluminum salts (e.g., aluminum nitrate, aluminum sulfate), aluminum alkoxides (e.g., aluminum isopropoxide), alkali metal aluminates (e.g., sodium aluminate, potassium aluminate), and any combination thereof.

The amorphous silica source comprises predominantly colloidal silica. The amorphous silica source can optionally contain, in minor amount, any type of amorphous silica other than colloidal silica. For example, the amorphous silica source can optionally contain, in minor amount, fumed silica, precipitated silica, alkali metal silicates (e.g., sodium silicate, potassium silicate), tetraalkyl orthosilicates (e.g., tetraethyl orthosilicate), and any combination thereof.

The reaction mixture used to form Al-SSZ-82 is preferably free or essentially free of a crystalline aluminosilicate molecular sieve of FAU framework structure (e.g., zeolite Y). The term “essentially free” typically will mean that the reaction mixture composition optionally comprises less than less than 0.1 wt. %, and, more preferably, less than 0.05 wt. % of the aluminosilicate molecular sieve of FAU framework structure.

The alkali metal cation [M] is preferably selected from the group consisting of sodium, potassium, lithium, rubidium, cesium, and mixtures thereof, preferably sodium and/or potassium, more preferably sodium. Suitable alkali metal sources include alkali metal hydroxides, such as sodium hydroxide and/or potassium hydroxide.

The organic structure directing agent [Q] comprises a 1,6-bis(N-cyclohexylpyrrolidinium)hexane dication, represented by the following structure (1), respectively:

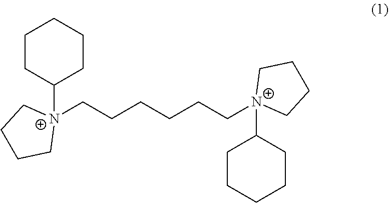 [SMILES: C1CCC([N+]2(CCCCCC[N+]3(C4CCCCC4)CCCC3)CCCC2)CC1]

The organic structure directing agent [Q] may be present in any suitable form, for example as a halide, such as an iodide or a bromide, or as a hydroxide, for instance in its hydroxide form.

The reaction mixture contains at least one source of hydroxide ions. Suitable sources of hydroxide ions include alkali metal hydroxides, ammonium hydroxide, and mixtures thereof; such as sodium hydroxide, potassium hydroxide, lithium hydroxide, rubidium hydroxide, cesium hydroxide, ammonium hydroxide, and mixtures thereof; more often sodium hydroxide, potassium hydroxide, ammonium hydroxide, and mixtures thereof; most often sodium hydroxide and/or potassium hydroxide. The organic structure directing agent and/or aluminum hydroxide can be used to provide hydroxide ions.

The reaction mixture further comprises an amount of seed crystals of a crystalline molecular sieve having an SSZ-82 framework (e.g., borosilicate SSZ-82, aluminosilicate SSZ-82). The amount of seed crystals is not particularly limited and typically corresponds to 0.1 o 25 wt. % (e.g., 0.1 to 10 wt. %), based on a total weight of silica in the reaction mixture. The use of SSZ-82 crystals as seed material can be advantageous in decreasing the time necessary for complete crystallization to occur and/or to minimize the formation of other crystalline impurities.

The reaction mixture components can be supplied by more than one source. Also, two or more reaction mixture components can be provided by one source.

The reaction mixture can be prepared by any conceivable means, wherein mixing by agitation is preferred, preferably by means of stirring. The reaction mixture can be prepared in batch, continuous, or semi-continuous mode.

The reaction mixture can be in the form of a solution, a colloidal dispersion (colloidal sol), gel, or paste, with a gel being preferred.

### Crystallization and Post-Synthesis Treatment

The reaction mixture is then subject to crystallization conditions suitable for the aluminosilicate zeolite to form. Crystallization of the aluminosilicate zeolite may be carried out under static or stirred conditions in a suitable reactor vessel, such as for example Teflon® lined or stainless steel autoclaves placed in a convection oven maintained at an appropriate temperature.

The crystallization in step (b) of the method is typically carried out at a temperature of from 100° C. to 200° C. (e.g., 140° C. to 180° C.) for a time sufficient for crystallization to occur at the temperature used. For instance, at higher temperatures, the crystallization time may be reduced. For instance, the crystallization conditions in step (b) of the method may include heating for a period of from 1 day to 30 days (e.g., at least 1 day or at least 5 days or at least 10 days up to 25 days or 21 days). The crystallization time can be established by methods known in the art such as by sampling the synthesis mixture at various times and determining the yield and X-ray crystallinity of precipitated solid. Unless indicated otherwise herein, the temperature measured is the temperature of the surrounding environment of the material being heated, for example the temperature of the atmosphere in which the material is heated. Preferably, the crystallization is carried out under autogenous pressure, preferably in an autoclave.

Typically, the aluminosilicate zeolite is formed in solution and can be recovered by standard means, such as by centrifugation or filtration. The separated aluminosilicate zeolite can also be washed, recovered by centrifugation or filtration and dried.

As a result of the crystallization process, the recovered as-made product contains within its pores at least a portion of the organic structure directing agent used in the synthesis. The as-made aluminosilicate zeolite recovered from step (c) may thus be subjected to thermal treatment or other treatment to remove part or all of the organic structure directing agent incorporated into its pores during the synthesis. Thermal treatment (e.g., calcination) of the as-synthesized aluminosilicate zeolite typically exposes the materials to high temperatures sufficient to remove part or all of the organic structure directing agent, in an atmosphere selected from air, nitrogen, ozone or a mixture thereof in a furnace. The thermal treatment may be performed at a temperature of from 300° C. to 800° C. (e.g., 400° C. to 650° C.) for a period of time ranging from 1 hour to 10 hours (e.g., 3 hours to 6 hours). The thermal treatment (e.g., calcination) may be carried out in a box furnace in dry air, which has been exposed to a drying tube containing drying agents that remove water from the air. The thermal treatment may first be carried out under a nitrogen atmosphere and then the atmosphere may be switched to air and/or ozone.

The aluminosilicate zeolite may also be subjected to an ion-exchange treatment, for example, with aqueous ammonium salts (e.g., ammonium nitrates, ammonium chlorides, and ammonium acetates) in order to remove remaining alkali metal cations and to replace them with protons thereby producing the acid form of the zeolite. To the extent desired, the original cations of the as-made material (e.g., alkali metal cations) can be replaced by ion exchange with other cations. Preferred replacing cations can include hydrogen ions, hydrogen precursor (e.g., ammonium ions), and mixtures thereof. The ion exchange step may take place after the as-made zeolite is dried. The ion-exchange step may take place either before or after a calcination step.

### Characterization of the Zeolite

The aluminosilicate SSZ-82 zeolite can have a SiO₂/Al₂O₃ molar ratio in a range of from 20 to 150 (e.g., 20 to 100, 20 to 50, or 20 to 40, or 25 to 60, 25 to 150, or 25 to 100, or 25 to 50, or 25 to 40). The SiO₂/Al₂O₃ molar ratio of zeolites may be determined by conventional analysis.

Aluminosilicate SSZ-82 crystals produced in accordance with the methods described herein can have a d50 crystal size of 2.0 μm or less (e.g., 1.5 μm or less, or 0.5 to 2.0 μm, or 0.5 to 1.5 μm). More preferably, aluminosilicate SSZ-82 crystals can have a d90 crystal size that is 2.0 μm or less, (e.g., 1.5 μm or less, or 0.5 to 2.0 μm, or 0.5 to 1.5 μm). Aluminosilicate SSZ-82 crystals may have both a d50 and a d90 value as described above.

The crystal size is based on individual crystals. Crystal size is the length of longest diagonal of the three-dimensional crystal. Direct measurement of the crystal size can be performed using microscopy methods, such as SEM and TEM. For example, measurement by SEM involves examining the morphology of materials at high magnifications (typically 1000× to 100,000×). The SEM method can be performed by distributing a representative portion of the molecular sieve powder on a suitable mount such that individual particles are reasonably evenly spread out across the field of view at 1000× to 100,000× magnification. From this population, a statistically significant sample of random individual crystals (e.g., 50-200) are examined and the longest diagonal of the individual crystals are measured and recorded. (Particles that are clearly large polycrystalline aggregates should not be included the measurements.) Based on these measurements, the d50 and d90 of the sample crystal sizes is calculated.

Applicants have discovered that the synthesis method described herein is capable of producing a high phase purity aluminosilicate SSZ-82 zeolite (i.e., phase purities of 95% by weight to more than 99% by weight, as determined by Rietveld XRD analysis, for example). The term “phase purity” used herein with respect to a zeolite means the amount of a single crystalline phase of the zeolite (e.g., based on weight) relative to total weight of all phases (crystalline and amorphous) in the zeolite substance. Thus, while other crystalline phases may be present in the aluminosilicate SSZ-82 zeolite, the aluminosilicate SSZ-82 zeolite comprises at least about 95% by weight SSZ-82 as a primary crystalline phase, preferably at least 98% by weight percent SSZ-82, and even more preferably at least 99% by weight or at least about 99.9% by weight SSZ-82, wherein the weight percent SSZ-82 is provided relative to the total weight of the zeolite crystalline phases present in the composition.

The powder X-ray diffraction data reported herein were collected by standard techniques using copper K-alpha radiation. Minor variations in the diffraction pattern can result from variations in the mole ratios of the framework species of the particular sample due to changes in lattice constants. In addition, sufficiently small crystals will affect the shape and intensity of peaks, leading to significant peak broadening. Minor variations in the diffraction pattern can also result from variations in the organic compound used in the preparation. Calcination can also cause minor shifts in the XRD pattern. Notwithstanding these minor perturbations, the basic crystal lattice structure remains unchanged.

### EXAMPLES

The following examples are illustrative and are intended to be non-limiting.

### Example 1

### Synthesis of Al-SSZ-82

The following components were added in order to a Teflon liner: 3.28 g deionized H₂O, 3.04 g NaOH solution (1 M), 2.75 g 1,6-bis(N-cyclohexylpyrrolidinium)hexane dihydroxide solution (20.5 wt. %), 0.06 g aluminum hydroxide (Alfa Aesar, 80.9%), 2.00 g LUDOX® HS-40 colloidal silica (40% solids dispersion of silica), and 0.08 g B-SSZ-82 seeds for a final molar ratio in the gel of 1.00 SiO₂/0.02 Al₂O₃/0.25 NaOH/0.10 1,6-bis(N-cyclohexylpyrrolidinium)hexane dihydroxide/0.10 B-SSZ-82 seeds/40.00 H₂O. The liner was sealed in a stainless steelautoclave and synthesized in a 160° C. oven with rotation at 43 rpm for 20 days. After crystallization, the solid product was isolated by filtration, washed with excess deionized H₂O, and dried in a 95° C. oven.

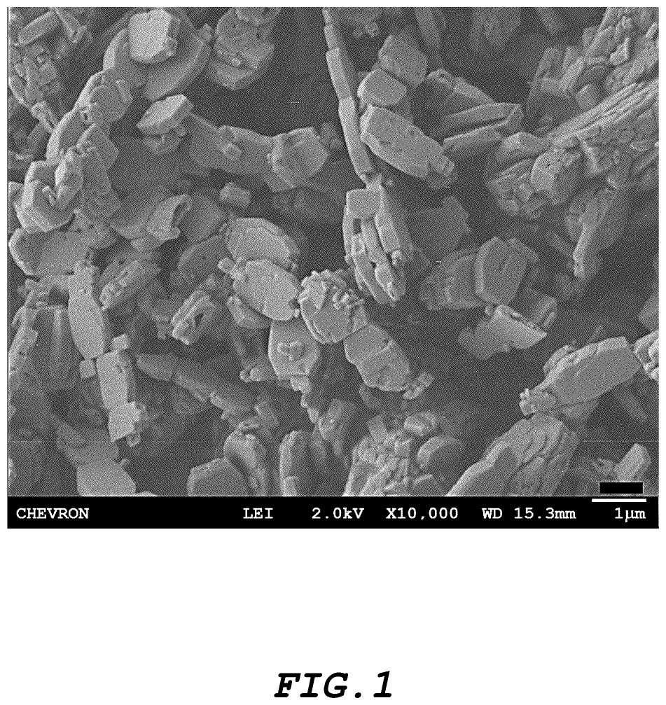

A SEM image of the as-made product is shown in FIG. 1.

A sample of the as-made product was calcined to 595° C. in flowing air for 5 hours to remove the organic structure directing agent using standard calcination protocol.

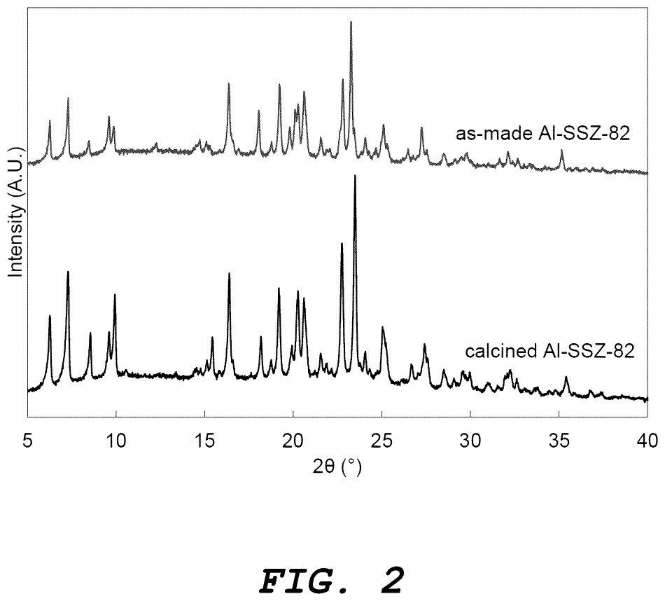

Analysis of the as-made and calcined products by powder XRD (FIG. 2) indicated that both products were pure phase SSZ-82.

The as-made product and the calcined product each had a SiO₂/Al₂O₃ molar ratio of 33, as determined by inductively coupled plasma atomic emission spectroscopy (ICP-AES).

A sample of the calcined material was then ion-exchanged to the NH₄-form by heating in a solution of ammonium nitrate (typically, 1 g NH₄NO₃/1 g zeolite in 10 mL deionized water at 95° C. for at least 2 hours). The zeolite was then filtered. This was repeated twice for a total of 3 exchanges. The zeolite was washed with deionized water to a conductivity of less than 50 μS/cm and dried in air at 95° C. The resulting NH₄-form zeolite was converted to the H-form by calcination using standard calcination protocol.

Analysis by n-propylamine temperature-programmed desorption showed that the product had an acid site density of 922 μmol H⁺/g.

Analysis of nitrogen physisorption data by the t-plot method showed that the product had a micropore volume 0.22 cm³/g.

### Example 2

Example 1 was repeated except that 0.03 g of aluminum hydroxide was used. After 14 days of heating at 160° C., pure phase SSZ-82 product was obtained, as identified by its powder XRD pattern.

### Examples 3-15 (Comparative)

These Examples were conducted in the same manner as described in Example 1, with varying Si/Al molar ratios, Si and Al sources, and process conditions as shown in Table 2. The source of colloidal silica was LUDOX® HS-40 (Grace). The source of pseudoboehmite was Versal™ 250 (UOP).

The results show that the products obtained were amorphous materials, mixed-phase materials (i.e., materials containing >10% by weight phases other than SSZ-82) or zeolitic materials with non-SSZ-82 framework structures (e.g., MOR).

TABLE 2

| | reaction | reaction | | | SiO₂ | Al₂O₃ | 1M | |
|---|---|---|---|---|---|---|---|---|
| | temp. | time | silica | alumina | source | source | NaOH | OSDA |
| Ex. | [° C.] | [d] | source | source | [g] | [g] | [g] | [g] |
| 3 | 160 | 14 | colloidal SiO₂ | Al(OH)₃ | 2.00 | 0.06 | 3.72 | 2.75 |
| 4 | 160 | 21 | colloidal SiO₂ | Al(OH)₃ | 2.00 | 0.06 | 3.72 | 2.75 |
| 5 | 160 | 14 | colloidal SiO₂ | Al(OH)₃ | 2.00 | 0.03 | 3.72 | 2.75 |
| 6 | 160 | 7 | colloidal SiO₂ | Al(OH)₃ | 2.00 | 0.11 | 3.04 | 2.75 |
| 7 | 160 | 21 | colloidal SiO₂ | Al₂(SO₄)₃•8H₂O | 2.00 | 0.11 | 3.04 | 2.75 |
| 8 | 160 | 14 | colloidal SiO₂ | Al₂(SO₄)₃•8H₂O | 2.25 | 0.03 | 3.42 | 3.10 |
| 9 | 160 | 14 | colloidal SiO₂ | Al₂(SO₄)₃•8H₂O | 2.25 | 0.02 | 3.42 | 3.10 |
| 10 | 160 | 33 | fumed SiO₂ | pseudoboehmite | 0.90 | 0.20 | 3.71 | 3.01 |
| 11 | 160 | 17 | fumed SiO₂ | pseudoboehmite | 0.90 | 0.13 | 3.71 | 3.01 |
| 12 | 160 | 24 | fumed SiO₂ | pseudoboehmite | 0.90 | 0.13 | 3.71 | 3.01 |
| 13 | 160 | 14 | fumed SiO₂ | pseudoboehmite | 0.80 | 0.07 | 3.30 | 2.67 |
| 14 | 160 | 14 | fumed SiO₂ | pseudoboehmite | 0.80 | 0.06 | 3.30 | 2.67 |
| 15 | 160 | 14 | fumed SiO₂ | pseudoboehmite | 0.80 | 0.04 | 3.30 | 2.67 |

| | | B-SSZ- | final molar ratio in gel | | | | | | |
|---|---|---|---|---|---|---|---|---|---|
| | | 82 | | | | | | B-SSZ- | |
| | H₂O | seeds | | | | | | 82 | XRD |
| Ex. | [g] | [g] | SiO₂ | Al₂O₃ | NaOH | OSDA | H₂O | seeds | Result |
| 3 | 2.63 | 0.08 | 1.00 | 0.02 | 0.30 | 0.10 | 40 | 0.10 | SSZ-82 + |
| | | | | | | | | | unknown |
| 4 | 2.63 | 0.08 | 1.00 | 0.02 | 0.30 | 0.10 | 40 | 0.10 | MOR |
| 5 | 2.63 | 0.08 | 1.00 | 0.01 | 0.30 | 0.10 | 40 | 0.10 | SSZ-82 + |
| | | | | | | | | | unknown |
| 6 | 3.28 | 0.08 | 1.00 | 0.04 | 0.25 | 0.10 | 40 | 0.10 | SSZ-82 + |
| | | | | | | | | | gibbsite |
| 7 | 3.28 | 0.08 | 1.00 | 0.04 | 0.25 | 0.10 | 40 | 0.10 | SSZ-82 + |
| | | | | | | | | | MOR |
| 8 | 3.68 | 0.09 | 1.00 | 0.02 | 0.25 | 0.10 | 40 | 0.10 | quartz + |
| | | | | | | | | | SSZ-82 |
| 9 | 3.68 | 0.09 | 1.00 | 0.01 | 0.25 | 0.10 | 40 | 0.10 | quartz + |
| | | | | | | | | | SSZ-82 |
| 10 | 4.44 | 0.09 | 1.00 | 0.10 | 0.25 | 0.10 | 40 | 0.10 | amorphous |
| 11 | 4.46 | 0.09 | 1.00 | 0.07 | 0.25 | 0.10 | 40 | 0.10 | amorphous |
| 12 | 4.46 | 0.09 | 1.00 | 0.07 | 0.25 | 0.10 | 40 | 0.10 | MOR |
| 13 | 3.97 | 0.08 | 1.00 | 0.04 | 0.25 | 0.10 | 40 | 0.10 | SSZ-82 + |
| | | | | | | | | | unknown |
| 14 | 3.98 | 0.08 | 1.00 | 0.03 | 0.25 | 0.10 | 40 | 0.10 | SSZ-82 + |
| | | | | | | | | | unknown |
| 15 | 3.98 | 0.08 | 1.00 | 0.02 | 0.25 | 0.10 | 40 | 0.10 | SSZ-82 + |
| | | | | | | | | | unknown |

1. A method of making an aluminosilicate zeolite having a framework structure of SSZ-82, the method comprising:
(1) preparing a reaction mixture comprising:
(a) an amorphous alumina source comprising predominantly aluminum hydroxide;
(b) an amorphous silica source comprising predominantly colloidal silica;
(c) a source of an alkali metal cation [M];
(d) an organic structure directing agent [Q] comprising a 1,6-bis(N-cyclohexylpyrrolidinium)hexane dication;
(e) hydroxide ions;
(f) seed crystals, wherein the seed crystals comprise a crystalline molecular sieve having an SSZ-82 framework; and
(g) water;
(2) heating the reaction mixture under crystallization conditions including a temperature of from 100° C. to 200° C. for a time sufficient to form crystals of the aluminosilicate zeolite; and
(3) recovering at least a portion of the aluminosilicate zeolite from step (2).

2. The method of claim 1, wherein the amorphous alumina source comprises greater than 90% by weight aluminum oxide.

3. The method of claim 1, wherein the amorphous silica source comprises greater than 90% by weight colloidal silica.

4. The method of claim 1, wherein the source of the alkali metal cation comprises an alkali metal hydroxide.

5. The method of claim 1, wherein the alkali metal cation is selected from the group consisting of sodium, potassium, and mixtures thereof.

6. The method of claim 1, wherein the organic structure directing agent [Q] is in its hydroxide form.

7. The method of claim 1, wherein an amount of seed crystals corresponds to 0.1 to 25% based on a total amount of silica in the reaction mixture.

8. The method of claim 1, wherein the reaction mixture has a composition, in terms of molar ratios, as follows:

| | |
|---|---|
| SiO₂/Al₂O₃ | 20 to 150 |
| M/SiO₂ | 0.05 to 0.50 |
| Q/SiO₂ | 0.05 to 0.30 |
| OH/SiO₂ | 0.10 to 0.80 |
| H₂O/SiO₂ | 10 to 80. |

9. The method of claim 1, wherein the reaction mixture has a composition, in terms of molar ratios, as follows:

| | |
|---|---|
| SiO₂/Al₂O₃ | 25 to 100 |
| M/SiO₂ | 0.10 to 0.30 |
| Q/SiO₂ | 0.05 to 0.20 |
| OH/SiO₂ | 0.20 to 0.60 |
| H₂O/SiO₂ | 20 to 60. |

10. The method according to claim 1, wherein the reaction mixture is free of a crystalline aluminosilicate molecular sieve having an FAU framework structure.

11. The method of claim 1, wherein the aluminosilicate zeolite has a phase purity of at least 95% by weight.

12. The method of claim 1, wherein the crystallization conditions in step (2) include the heating under autogenous pressure.

13. The method of claim 1, further comprising treating the aluminosilicate zeolite recovered in step (3) to remove at least part of the organic structure directing agent [Q}.
